(19) United States
(12) Patent Application Publication
(10) Pub. No.: US 2016/0160000 A1
(43) Pub. Date: Jun. 9, 2016

(54) PROCESS FOR PRODUCING HEAT-EXPANDABLE MICROSPHERES

(71) Applicant: MATSUMOTO YUSHI-SEIYAKU CO., LTD., Osaka (JP)

(72) Inventors: Koichi SAKABE, Yao-shi, Osaka (JP); Katsushi MIKI, Yao-shi, Osaka (JP); Yasuyuki NOMURA, Yao-shi, Osaka (JP)

(73) Assignee: MATSUMOTO YUSHI-SEIYAKU CO., LTD., Yao-shi, Osaki (JP)

(21) Appl. No.: 14/908,313

(22) PCT Filed: Aug. 25, 2014
(86) PCT No.: PCT/JP2014/072084

§ 371 Date: Jan. 28, 2016

(30) Foreign Application Priority Data
Aug. 28, 2013 (JP) 2013-176293

(51) Int. Cl. C08J 9/20; C08J 9/236

(52) U.S. Cl. CPC C08J 9/20; C08J 9/236; C08J 2300/22

(57) ABSTRACT

Provided is a process for efficiently producing heat-expandable microspheres having high solvent resistance. The process produces the heat-expandable microspheres composed of a shell of a thermoplastic resin and a blowing agent encapsulated therein and vaporizable by heating, and includes the steps of preparing an aqueous suspension by dispersing an oily mixture containing a polymerizable component, the blowing agent, and a polymerization initiator containing, as an essential component, a peroxide A having a theoretical active oxygen content of at least 7.8%, and polymerizing the polymerizable component in the oily mixture.

### TECHNICAL FIELD

Certain implementations refer to a process for producing heat-expandable microspheres.

### BACKGROUND

Heat-expandable microspheres composed of a shell of thermoplastic resin and a blowing agent encapsulated therein are generally called heat-expandable microcapsules. The monomers constituting the thermoplastic resin usually include vinylidene chloride, (meth)acrylonitrile monomers, and (meth)acrylate ester monomers. The blowing agent mainly used includes hydrocarbons such as isobutane and isopentane (refer to PTL 1).

Known heat-expandable microcapsules having high solvent resistance include microcapsules produced by polymerizing a composition containing a high ratio, i.e., at least 80 wt %, of a nitrile monomer (refer to PTL 2). The solvent resistance achieved by nitrile monomers is, however, sometimes insufficient in recently extended uses of heat-expandable microcapsules. Thus the development of heat-expandable microcapsules having high solvent resistance is desired.

### CITATION LIST

### Patent Literature

PTL 1: USP 3615972

PTL 2: JP-A-1997-19635

### SUMMARY

### Technical Problem

The object of the present invention is to provide a process for efficiently producing heat-expandable microspheres having high solvent resistance.

### Solution to Problem

The inventors diligently studied to solve the problem mentioned above, and found that the problem could be solved by using a specific polymerization initiator to achieve the present invention.

The process for producing heat-expandable microspheres produces heat-expandable microspheres comprising a shell of a thermoplastic resin and a blowing agent encapsulated therein and vaporizable by heating. The process comprises the steps of preparing an aqueous suspension by dispersing an oily mixture in an aqueous dispersion medium, wherein the oily mixture contains a polymerizable component, the blowing agent, and a polymerization initiator containing, as an essential component, a peroxide A having a theoretical active oxygen content of at least 7.8%, and polymerizing the polymerizable component in the oily mixture.

The process for producing heat-expandable microspheres should preferably meet at least one of the requirements (A) to (E) mentioned below.

(A) The polymerizable component contains a nitrile monomer as an essential component.

(B) The peroxide A is a peroxyester and/or a peroxyketal.

(C) The peroxide A is a compound containing a ring structure in a molecule.

(D) The number of the active oxygen bonds of the peroxide A is in the range of 2 to 5 per molecule.

(E) The molecular weight of the peroxide A is at least 275.

The heat-expandable microspheres are produced in the process mentioned above.

Hollow particles are produced by heating and expanding the heat-expandable microspheres. The outer surface of the hollow particles should preferably be coated with fine particles.

The composition preferably contains a base component and at least one particulate material selected from the group consisting of the heat-expandable microspheres and hollow particles mentioned above. The composition should preferably be a film-forming composition.

Formed product may be manufactured using such compositions.

The process for producing heat-expandable microspheres enables efficient production of heat-expandable microspheres having high solvent resistance.

The hollow particles have high solvent resistance, because the hollow particles are produced by heating and expanding the heat-expandable microspheres produced in the process mentioned above.

The composition has high solvent resistance owing to the heat-expandable microspheres and/or hollow particles contained in the composition. In particular, the composition used as a film-forming composition shows good storage stability.

The formed product has high solvent resistance.

### BRIEF DESCRIPTION OF DRAWINGS

FIG. 1: Schematic diagram illustrating an example of the heat-expandable microspheres.

FIG. 2: Schematic diagram illustrating an example of the hollow particles.

### DETAILED DESCRIPTION

Process for producing heat-expandable microspheres

The process includes the steps of, at first, preparing an aqueous suspension by dispersing an oily mixture of a polymerizable component, blowing agent and polymerization initiator in an aqueous dispersion medium, and then polymerizing the polymerizable component in the oily mixture.

The blowing agent is not specifically restricted if it vaporizes by heating, and includes C₃-C₁₃ hydrocarbons, such as propane, (iso)butane, (iso)pentane, (iso)hexane, (iso)heptane, (iso)octane, (iso)nonane, (iso)decane, (iso)undecane, (iso)dodecane, and (iso)tridecane; C₁₄-C₂₀ hydrocarbons, such as (iso)hexadecane and (iso)eicosane; hydrocarbons produced by fractional distillation of petroleum, such as pseudocumene, petroleum ethers, and normal paraffins or isoparaffins having an initial boiling point from 150° C. to 260° C. and/or a distillation range from 70° C. to 360° C.; their halides; fluorine-containing compounds such as hydrofluoroether; tetraalkyl silane; and compounds which decompose by heating and generate gases. One of or a combination of at least two of these blowing agents can be employed. The blowing agent can be any of linear, branched or alicyclic compounds, and is preferably an aliphatic compound.

The polymerizable component is polymerized into a thermoplastic resin which forms the shell of the thermo-expandable microspheres. The polymerizable component contains a monomer component as an essential component, and can contain a cross-linking agent.

The monomer component is generally called a (radically-)polymerizable monomer having a polymerizable double bond, and contains a moiety polymerizable through addition reaction.

The polymerizable component is not specifically restricted, and includes, for example, nitrile monomers such as acrylonitrile, methacrylonitrile, and fumaronitrile; carboxyl-group-containing monomers such as acrylic acid, methacrylic acid, ethacrylic acid, crotonic acid, cinnamic acid, maleic acid, itaconic acid, fumaric acid, citraconic acid, and chloromaleic acid; vinyl halide monomers, such as vinyl chloride; vinylidene halide monomers, such as vinylidene chloride; vinyl ester monomers, such as vinyl acetate, vinyl propionate and vinyl butyrate; (meth)acrylate monomers, such as methyl (meth)acrylate, ethyl (meth)acrylate, n-butyl (meth) acrylate, tbutyl (meth) acrylate, 2-ethylhexyl (meth) acrylate, stearyl (meth) acrylate, phenyl (meth) acrylate, isobornyl (meth) acrylate, cyclohexyl (meth) acrylate, benzyl (meth)acrylate, and 2-hydroxyethyl (meth)acrylate; (meth)acrylamide monomers, such as acrylamide, substituted acrylamide, methacrylamide and substituted methacrylamide; maleimide monomers, such as N-phenyl maleimide and N-cyclohexyl maleimide; styrene monomers, such as styrene and a-methyl styrene; ethylenically unsaturated monoolefin monomers, such as ethylene, propylene, and isobutylene; vinyl ether monomers, such as vinyl methyl ether, vinyl ethyl ether and vinyl isobutyl ether; vinyl ketone monomers, such as vinyl methyl ketone; N-vinyl monomers, such as N-vinyl carbazole and N-vinyl pyrolidone; and vinyl naphthalene salts. The term, “(meth)acryl”, means acryl or methacryl.

The polymerizable component should preferably contain at least one monomer component selected from the group consisting of nitrile monomers, carboxyl-group-containing monomers, (meth)acrylate monomers, styrene monomers, vinyl ester monomers, acrylamide monomers, and vinylidene halide monomers.

The polymerizable component containing a nitrile monomer as an essential monomer component is preferable to produce heat-expandable microspheres of high solvent resistance. The heat-expandable microspheres produced from the nitrile monomer and contained in the film-forming composition mentioned below contribute to improved storage stability of the film-forming composition. Preferable nitrile monomers are acrylonitrile and methacrylonitrile for their availability and high heat and solvent resistance.

For nitrile monomers containing acrylonitrile (AN) and methacrylonitrile (MAN), the weight ratio of acrylonitrile (AN) to methacrylonitrile (MAN) is not specifically restricted, and should preferably range from 10:90 to 90:10, more preferably from 20:80 to 80:20, and further more preferably from 30:70 to 80:20. A weight ratio of AN to MAN less than 10:90 can result in poor gas impermeability of the microspheres. On the other hand, a weight ratio of AN to MAN greater than 90:10 can result in insufficient expansion ratio of the microspheres. The ratio of AN to MAN for the heat-expandable microspheres contained in the film-forming composition mentioned below should preferably range from 10:90 to 90:10, more preferably from 20:80 to 85:15, further more preferably from 30:70 to 80:20, yet further more preferably from 30:70 to 75:25, and most preferably from 50:50 to 70:30 in order to achieve good storage stability of the film-forming composition.

The weight ratio of the nitrile monomers is not specifically restricted, and should preferably range from 20 to 100 wt % of the monomer component, more preferably from 30 to 100 wt %, further more preferably from 40 to 100 wt %, yet further more preferably from 50 to 100 wt %, and most preferably from 60 to 100 wt %. A monomer component containing less than 20 wt % of the nitrile monomers can cause poor solvent resistance of resultant microspheres. The weight ratio of the nitrile monomers in the monomer component for the heat-expandable microspheres which is contained in the film-forming composition mentioned below should preferably at least 50 wt %, more preferably at least 60 wt %, further more preferably at least 70 wt %, yet further more preferably at least 80 wt %, and most preferably at least 90 wt %. The upper limit of the preferable weight ratio of the nitrile monomers is 100 wt %. The weight ratio of the nitrile monomers within the range mentioned above will contribute to good storage stability of the film-forming composition containing the microspheres.

A polymerizable component containing a carboxyl-group-containing monomer as an essential monomer component will contribute to excellent heat and solvent resistance of resultant heat-expandable microspheres. Acrylic acid and methacrylic acid are preferable carboxyl-group-containing monomers owing to their availability and improved heat resistance of resultant heat-expandable microspheres.

The weight ratio of the carboxyl-group-containing monomers is not specifically restricted, and should preferably range from 10 to 70 wt % of the monomer component, more preferably from 15 to 60 wt %, further more preferably from 20 to 50 wt %, yet further more preferably from 25 to 45 wt %, and most preferably from 30 to 40 wt %. A weight ratio of the carboxyl-group-containing monomers less than 10 wt % can cause insufficient heat resistance of resultant heat-expandable microspheres. On the other hand, a weight ratio of the carboxyl-group-containing monomers greater than 70 wt % can result in poor gas impermeability of the microspheres.

For a monomer component containing a nitrile monomer and carboxyl-group-containing monomer as essential components, the total weight ratio of the nitrile monomer and carboxyl-group-containing monomer should preferably be at least 50 wt % of the monomer component, more preferably at least 60 wt %, further more preferably at least 70 wt %, yet further more preferably at least 80 wt %, and most preferably at least 90 wt %.

In this case, the ratio of the carboxyl-group-containing monomer to the total weight ratio of the nitrile monomer and carboxyl-group-containing monomer should preferably range from 10 to 70 wt %, more preferably from 15 to 60 wt %, further more preferably from 20 to 50 wt %, yet further more preferably from 25 to 45 wt %, and most preferably from 30 to 40 wt %. The ratio of the carboxyl-group-containing monomer less than 10 wt % can cause insufficiently improved heat and solvent resistance of resultant microspheres and lead to unstable expansion performance of resultant microspheres in a high temperature range over a long period of heating. On the other hand, the ratio of the carboxyl-group-containing monomer greater than 70 wt % can cause poor expansion performance of the resultant heat-expandable microspheres.

A polymerizable component containing vinylidene chloride monomers as a monomer component will improve the gas impermeability of resultant microspheres. A polymerizable component containing (meth)acrylate ester monomers and/or styrene monomers contributes to readily controllable thermal expansion performance of resultant heat-expandable microspheres. A polymerizable component containing (meth)acrylamide monomers will lead to improved heat resistance of resultant heat-expandable microspheres.

The weight ratio of at least one monomer selected from the group consisting of vinylidene chloride, (meth)acrylate monomers, (meth)acrylamide monomers, and styrene monomers should preferably be less than 50 wt % of the monomer component, more preferably less than 30 wt %, and most preferably less than 10 wt %. A weight ratio of such monomer of 50 wt % or greater can cause poor heat resistance of resultant microspheres.

The polymerizable component can contain a polymerizable monomer (a cross-linking agent) having at least two polymerizable double bonds other than the monomers mentioned above. Polymerization of the polymerizable component with the cross-linking agent will minimize the decrease of the ratio of the blowing agent retained in thermally expanded microspheres (retention ratio of a blowing agent encapsulated in microspheres) and achieve efficient thermal expansion of the microspheres.

The cross-linking agent is not specifically restricted, and includes, for example, aromatic divinyl compounds, such as divinylbenzene; and di(meth)acrylate compounds, such as allyl methacrylate, triacrylformal, triallyl isocyanate, ethylene glycol di(meth)acrylate, diethylene glycol di(meth)acrylate, 1,4-butanediol di(meth)acrylate, 1,9-nonanediol di(meth)acrylate, PEG (200) di(meth)acrylate, PEG (600) di(meth)acrylate, trimethylolpropane trimethacrylate, pentaerythritol tri(meth)acrylate, dipentaerythritol hexaacrylate, and 2-butyl-2-ethyl-1,3-propanediol diacrylate. One of or a combination of at least two of those cross-linking agents can be used.

The amount of the cross-linking agent is not specifically restricted, and should preferably range from 0.01 to 5 parts by weight to 100 parts by weight of the monomer component, more preferably from 0.1 to 1 part by weight, and most preferably from 0.2 to less than 1 part by weight. The amount of the cross-linking agent can also range from 0 to 0.01 parts by weight to 100 parts by weight of the monomer component or can be 0 parts by weight.

In the process, an oily mixture containing a polymerization initiator is employed in order to polymerize the polymerizable component in the mixture in the presence of the polymerization initiator.

The polymerization initiator contains a peroxide, and the peroxide (hereinafter sometimes referred to as a peroxide A) must have a theoretical active oxygen content of at least 7.8%. A peroxide having a theoretical active oxygen content of at least 7.8% will achieve high solvent resistance of resultant heat-expandable microspheres.

The theoretical active oxygen content of the peroxide A should preferably be at least 8.0%, more preferably at least 8.3%, further more preferably at least 8.8%, yet further more preferably at least 9.3%, and most preferably at least 9.8%. The upper limit of the theoretical active oxygen content of the peroxide A is 30%. The theoretical active oxygen content of peroxides is generally calculated by the following expression.

$$Theoretical active oxygen content = \frac{16 \times ( numbe r of activ e oxygen bonds )}{Molecular weight} \times 100$$

The peroxide A includes, for example, peroxyesters, such as t-butyl peroxyacetate, t-amyl peroxyacetate, t-butyl peroxyisopropyl monocarbonate, t-amyl peroxypivalate, t-butyl peroxybenzoate, t-butyl peroxyneoheptanate, t-hexyl peroxyisopropyl monocarbonate, and di-t-butyl peroxyisophthalate; peroxycarbonates, such as t-butyl peroxyisopropyl carbonate, t-amyl peroxyisopropyl carbonate, and 1,6-bis-(t-butyl peroxycarbonyloxy)hexane; dialkyl peroxides, such as di-t-amyl peroxide, 2,5-dimethyl-2 5-di(t-butylperoxy)hexyne-3, 2,5-dimethyl-2,5-di(t-butylperoxy)hexane, and 1,3-di(2-t-butylperoxyisopropyl)benzene; peroxyketals, such as 2,2-di(t-butylperoxy)butane, 1,1-di(t-butylperoxy)cyclohexane, 1, 1-di(t-amylperoxy) cyclohexane, ethyl 3,3-di(t-butylperoxy)butylate, 1,1-bis(t-butylperoxy)-3,3,5-trimethyl cyclohexane, 1,1-bis(t-hexylperoxy) cyclohexane, n-butyl-4,4-di(t-butylperoxy)valerate, 1,1-bis(t-hexylperoxy)3,3,5-trimethyl cyclohexane, and 2,2-bis(4,4-di-t-butylperoxycyclohexy)propane; ketone peroxides, such as methylethyl ketone peroxide; hydroperoxides, such as t-butyl hydroperoxide, t-amyl hydroperoxide, 1,1,3,3-tetramethylbutyl hydroperoxide, cumene hydroperoxide, p-menthane hydroperoxide, t-butylperoxyaryl monocarbonate, diisopropyl benzenehydroperoxide, and 3,3′, 4,4′-tetra(t-butylperoxycarbonyl)benzophenon. One of or a combination of at least two of those peroxides A can be used.

Peroxyesters and/or peroxyketals used for the peroxide A are preferable for improved solvent resistance of resultant microspheres. A peroxide A having a ring structure in the molecule is preferable for improved heat resistance of resultant microspheres. The ring structure includes those composed of aliphatic hydrocarbons or aromatic hydrocarbons, and a ring structure composed of an aliphatic hydrocarbons is preferable for improved heat resistance of resultant microspheres.

The number of active oxygen bonds per molecule of the peroxide A is not specifically restricted, and should preferably be at least 1, more preferably within the range from 2 to 5, further more preferably within the range from 2 to 4, and most preferably 2 or 3. The upper limit of the number of the active oxygen bonds per molecule of the peroxide A is preferably 5. The number of active oxygen bonds per molecule of the peroxide A within the range from 2 to 5 can contribute to decreased amount of a polymerization initiator required for the polymerization of heat-expandable microspheres so as to decrease the amount of the terminals of the polymerization initiator remaining in the shell of the microspheres. It can contribute to improved solvent resistance of the microspheres.

The molecular weight of the peroxide A is not specifically restricted, and should preferably be at least 275, more preferably at least 290, further more preferably at least 300, and most preferably at least 315. The upper limit of the molecular weight of the peroxide A should preferably be 600. The peroxide A having a molecular weight less than 275 can cause insufficient heat resistance of resultant heat-expandable microspheres. On the other hand, the peroxide A having a molecular weight greater than 600 can cause insufficient solvent resistance of resultant heat-expandable microspheres.

The 10-hr half-life temperature of the peroxide A is not specifically restricted, and should preferably be at least 40° C., more preferably at least 50° C., further more preferably at least 60° C., and most preferably at least 70° C. The upper limit of the 10-hr half life temperature of the peroxide A is preferably 180° C. The peroxide A having a 10-hr half-life temperature lower than 40° C. can cause insufficient heat resistance of resultant heat-expandable microspheres. On the other hand, the peroxide A having a 10-hr half-life temperature higher than 180° C. can cause insufficient solvent resistance of resultant heat-expandable microspheres.

The weight ratio of the peroxide A in the polymerization initiator is not specifically restricted, and should preferably be at least 0.1 wt %, more preferably at least 1 wt %, further more preferably at least 10 wt %, and most preferably 100 wt %. A weight ratio of the peroxide A less than 0.1 wt % can fail to attain high solvent resistance of resultant heat-expandable microspheres.

The polymerization initiator can further contain a peroxide having theoretical active oxygen content of less than 7.8% (in other words, a peroxide other than the peroxide A) or an azo compound.

The peroxide other than the peroxide A includes peroxides generally used, for example, peroxydicarbonates, such as diisopropyl peroxydicarbonate, di-sec-butyl peroxydicarbonate, di-2-ethylhexyl peroxydicarbonate, and dibenzyl peroxydicarbonate; and diacyl peroxides, such as lauroyl peroxide and benzoyl peroxide.

The azo compound includes, for example, 2,2′-azobis(4-methoxy-2,4-dimethyl valeronitrile), 2,2′-azobisisobutylonitrile, 2,2′-azobis(2,4-dimethyl valeronitrile), 2,2′-azobis(2-methyl propionate), and 2,2′-azobis(2-methyl butylonitrile).

The amount of the polymerization initiator (active ingredient) is not specifically restricted, and should preferably range from 0.3 to 8.0 parts by weight to 100 parts by weight of the monomer component.

In the process, the oily mixture can further contain a chain transfer agent.

The aqueous dispersion medium contains water, such as deionized water, as the main component to disperse the oily mixture. The medium can further contain alcohols, such as methanol, ethanol and propanol, and hydrophilic organic solvents, such as acetone. The hydrophilic property mentioned refers to a property of a substance or mixture optionally miscible in water. The amount of the aqueous dispersion medium used in the process is not specifically restricted, and should range preferably from 100 to 1000 parts by weight to 100 parts by weight of the polymerizable component.

The aqueous dispersion medium can further contain an electrolyte, such as sodium chloride, magnesium chloride, calcium chloride, sodium sulfate, magnesium sulfate, ammonium sulfate, and sodium carbonate. One of or a combination of at least two of these electrolyte can be used. The amount of the electrolyte is not specifically restricted, and should preferably range from 0.1 to 50 parts by weight to 100 parts by weight of the aqueous dispersion medium.

The aqueous dispersion medium can contain at least one water-soluble compound selected from the group consisting of water-soluble 1,1-substitution compounds having a carbon atom bonded with a hetero atom and with a hydrophilic functional group selected from the group consisting of hydroxyl group, carboxylate (salt) group and phosphonate (salt) group, potassium dichromate, alkali metal nitrite salts, metal (III) halides, boric acid, water-soluble ascorbic acids, water-soluble polyphenols, water-soluble vitamin Bs, and water-soluble phosphonates (salts). The term “water-soluble” refers to a property of a substance soluble by at least 1 g in 100 g of water.

The amount of the water-soluble compound contained in the aqueous dispersion medium is not specifically restricted, and should preferably range from 0.0001 to 1.0 parts by weight to 100 parts by weight of the polymerizable component, more preferably from 0.0003 to 0.1 parts by weight, and most preferably from 0.001 to 0.05 parts by weight. Insufficient amount of the water-soluble compound can fail to exert sufficient effect by the water-soluble compound. On the other hand, excessive amount of the water-soluble compound can decrease the polymerization rate or increase the amount of the residue of the polymerizable component constituting the microspheres.

The aqueous dispersion medium can contain a dispersion stabilizer or dispersion stabilizing auxiliary in addition to the electrolytes and water-soluble compounds.

The dispersion stabilizer is not specifically restricted, and includes, for example, calcium triphosphate, magnesium pyrophosphate and calcium pyrophosphate produced by double reaction, colloidal silica, alumina sol, and magnesium hydroxide. One of or a combination of at least two of those dispersion stabilizers can be used.

The amount of the dispersion stabilizer should preferably range from 0.1 to 20 parts by weight to 100 parts by weight of the polymerizable component, and more preferably from 0.5 to 10 parts by weight.

The dispersion stabilizing auxiliary is not specifically restricted, and includes, for example, polymeric dispersion stabilizing auxiliaries; and surfactants, such as cationic surfactants, anionic surfactants, amphoteric surfactants, and nonionic surfactants. One of or a combination of at least two of those dispersion stabilizing auxiliaries can be used.

The aqueous dispersion medium is prepared by blending a water-soluble compound and optionally a dispersion stabilizer and/or dispersion stabilizing auxiliary with water (deionized water). The pH of the aqueous dispersion medium during polymerization is adjusted depending on the variants of the water-soluble compound, dispersion stabilizer, and dispersion stabilizing auxiliary.

The polymerization in the process can be carried out in the presence of sodium hydroxide or the combination of sodium hydroxide and zinc chloride.

In the process, the oily mixture is dispersed and emulsified in the aqueous dispersion medium to be formed into oil globules of a prescribed particle size.

The methods for dispersing and emulsifying the oily mixture include generally known dispersion techniques, such as agitation with a Homo-mixer (for example, a device produced by Tokushu Kika Kogyou Co., Ltd.), dispersion with a static dispersing apparatus such as a Static mixer (for example, a device produced by Noritake Engineering Co., Ltd.), membrane emulsification technique, and ultrasonic dispersion.

Then suspension polymerization is started by heating the dispersion in which the oily mixture is dispersed into oil globules in the aqueous dispersion medium. During the polymerization reaction, the dispersion should preferably be agitated gently to prevent the floating of monomers and sedimentation of polymerized heat-expandable microspheres.

The polymerization temperature can be settled optionally depending on the variant of the polymerization initiator, and should preferably be controlled within the range from 30 to 100° C., and more preferably from 40 to 90° C. The polymerization temperature should preferably be maintained for about 0.1 to 20 hours. The initial pressure for the polymerization is not specifically restricted, and should preferably be controlled within the range from 0 to 5.0 MPa and more preferably from 0.1 to 3.0 MPa in gauge pressure.

Heat-Expandable Microspheres

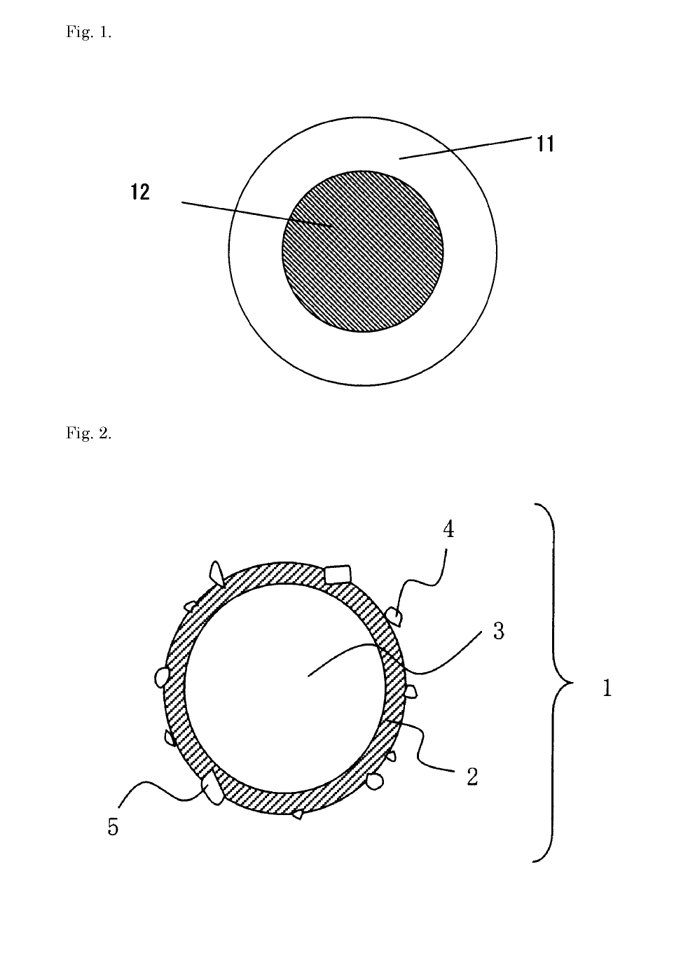

The heat-expandable microspheres are produced in the process mentioned above. The heat-expandable microspheres, as shown in FIG. 1, are composed of the shell 1 of a thermoplastic resin and a blowing agent 2 encapsulated therein and vaporizable by heating. The thermoplastic resin is composed of a copolymer produced by polymerizing the polymerizable component containing monomer components.

The mean particle size of the heat-expandable microspheres is not specifically restricted, and should preferably ranges from 1 to 100 μm, more preferably from 2 to 80 μm, further more preferably from 3 to 60 μm, and most preferably from 5 to 50 μm.

The coefficient of variation, CV, of the particle size distribution of the heat-expandable microspheres is not specifically restricted, and should preferably be not more than 35%, more preferably not more than 30%, and most preferably not more than 25%. The coefficient of variation, CV, can be calculated by the following mathematical expressions (1) and (2).

$$\begin{matrix}[ Math . 1 ] \\ CV = ( s / < x > ) \times 100 ( \% ) & ( 1 ) \\ s = {\{ {\sum }_{i = 1}^{n} {( xi - < x > )}^{2} / ( n - 1 ) \}}^{1 / 2} & ( 2 )\end{matrix}$$

(where s is a standard deviation of the particle size of the microspheres, <x> is a mean particle size of the microspheres, “xi” is the particle size of the i-th particle, and n represents the number of particles)

The thermal expansion performance of the heat-expandable microspheres usually decreases after the microspheres are immersed in a solvent. The solvent resistance of heat-expandable microspheres is evaluated by comparing the thermal expansion performance of the heat-expandable microspheres after immersion in a solvent (thermal expansion performance after solvent immersion) to the thermal expansion performance of the heat-expandable microspheres before immersion in a solvent (initial thermal expansion performance), and by calculating the percentage of the thermal expansion performance retained after the solvent immersion. The solvent resistance of the heat-expandable microspheres is measured and evaluated by the methods described in the following examples.

The solvent resistance of heat-expandable microspheres (represented by the thermal expansion performance retained after solvent immersion) is preferably at least 60% of the initial thermal expansion performance, more preferably at least 70%, further more preferably at least 80%, yet further more preferably at least 85%, yet further more preferably at least 90%, particularly more preferably at least 95%, and most preferably 100%. The upper limit of the solvent resistance of heat-expandable microspheres is 100%. Heat-expandable microspheres retaining less than 60% of thermal expansion performance after solvent immersion have poor solvent resistance, and a film-forming composition containing such heat-expandable microspheres can have poor storage stability.

The expansion-initiation temperature (Ts) of the heat-expandable microspheres is not specifically restricted, and should preferably be at least 70° C., more preferably at least 100° C., further more preferably at least 110° C., yet further more preferably at least 120° C., and most preferably at least 130° C. Heat-expandable microspheres having an expansion-initiation temperature lower than 70° C. can have insufficient heat resistance in some cases. On the other hand, heat-expandable microspheres having an expansion-initiation temperature higher than 200° C. can exhibit insufficient expansion ratio.

The maximum expansion temperature (Tm) of the heat-expandable microspheres is not specifically restricted, and should preferably be at least 100° C., more preferably at least 120° C., further more preferably at least 130° C., yet further more preferably at least 140° C., and most preferably at least 150° C. Heat-expandable microspheres having a maximum expansion temperature lower than 100° C. can have insufficient heat resistance in some cases. On the other hand, heat-expandable microspheres having a maximum expansion temperature higher than 300° C. can exhibit insufficient expansion ratio.

The weight ratio of unreacted monomers (hereinafter referred to as residual monomers) remaining after polymerization and contained in heat-expandable microspheres is not specifically restricted, and should preferably be not more than 2000 ppm, more preferably not more than 1500 ppm, further more preferably not more than 1000 ppm, yet further more preferably not more than 800 ppm, and most preferably not more than 400 ppm. The preferable lower limit of the weight ratio of the residual monomers is 0 ppm. A weight ratio of the residual monomers greater than 2000 ppm can result in the plasticization of the shell of the heat-expandable microspheres leading to poor solvent resistance of the microspheres, or can deteriorate the storage stability of the film-forming composition mentioned below which contains the heat-expandable microspheres.

The heat-expandable microspheres produced in the process have high solvent resistance to retain their expansion ratio while they are immersed in a solvent. Thus the heat-expandable microspheres can be used for a paint containing organic solvents, and used for synthetic leathers containing solvent-based polyurethane.

Hollow Particles

The hollow particles are produced by heating and expanding the heat-expandable microspheres mentioned above.

The hollow particles are lightweight and exhibit high solvent resistance in a composition or formed product.

The process for producing the hollow particles includes dry thermal expansion methods and wet thermal expansion methods. The thermal expansion temperature preferably ranges from 80° C. to 350° C.

The mean particle size of the hollow particles is not specifically restricted, and can be optionally designed according to the application of the microspheres. The mean particle size should preferably range from 0.1 to 1000 μm, and more preferably from 0.8 to 200 μm. The coefficient of variation, CV, of the particle size distribution of the hollow particles is not specifically restricted, and should preferably be not more than 30%, and more preferably not more than 25%.

The true specific gravity of the hollow particles is not specifically restricted, and should preferably range from 0.010 to 0.5, more preferably from 0.015 to 0.3 and most preferably from 0.020 to 0.2.

The hollow particles (1) can include fine particles (4 and 5) coating the outer surface of their shell (2) as shown in FIG. 2, and such hollow particles are hereinafter sometimes referred to as fine-particle-coated hollow particles.

The coating mentioned here mean that the fine particles (4 or 5) is in a state of adhesion (4) on the shell (2) of the hollow particles (1), or in a state of fixation in a dent (5) of the shell of the hollow particles as the result of the fine particles pushing into the thermoplastic shell melted by heat. The particle shape of the fine particles can be irregular or spherical. The fine-particle-coated hollow particles have improved handling property.

The mean particle size of the fine particles is not specifically restricted, and is selected depending on hollow particles to be coated. The mean particle size of the fine particles should preferably range from 0.001 to 30 μm, more preferably from 0.005 to 25 μm, and most preferably from 0.01 to 20 μm.

Fine particles of various materials including both inorganic and organic materials can be employed. The shape of the fine particles includes spherical, needle-like and plate-like shapes.

The fine particles include, for example, organic fine particles including metal soaps such as magnesium stearate, calcium stearate, zinc stearate, barium stearate, and lithium stearate; synthetic waxes, such as polyethylene wax, lauric amide, myristic amide, palmitic amide, stearic amide, and hydrogenated castor oil; and organic fillers, such as polyacrylamide, polyimide, nylon, polymethyl methacrylate, polyethylene, and polytetrafluoroethylene. The examples of inorganic fine particles include, for example, talc, mica, bentonite, sericite, carbon black, molybdenum disulfide, tungsten disulfide, carbon fluoride, calcium fluoride, and boron nitride; and other inorganic fillers, such as silica, alumina, isinglass, colloidal calcium carbonate, heavy calcium carbonate, calcium hydroxide, calcium phosphate, magnesium hydroxide, magnesium phosphate, barium sulfate, titanium dioxide, zinc oxide, ceramic beads, glass beads, and crystal beads.

The fine-particle-coated hollow particles are useful for preparing a paint composition or adhesive composition by blending the hollow particles in the compositions mentioned below.

The fine-particle-coated hollow particles can be produced by heating and expanding fine-particle-coated heat-expandable microspheres. The preferable process for producing the fine-particle-coated hollow particles includes the steps of blending heat-expandable microspheres and fine particles (blending step), and heating the mixture prepared in the blending step (for example, at a temperature higher than the softening point of the thermoplastic resin constituting the shell of the heat-expandable microspheres) to expand the heat-expandable microspheres and simultaneously adhere the fine particles on the outer surface of the shell of the resultant hollow particles (adhering step).

The true specific gravity of the fine-particle-coated hollow particles is not specifically restricted, and should preferably range from 0.01 to 0.5, more preferably from 0.03 to 0.4, further more preferably from 0.05 to 0.35, and most preferable from 0.07 to 0.30. The true specific gravity less than 0.01 can result in poor durability of the fine-particle-coated hollow particles. On the other hand, the true specific gravity greater than 0.5 can result in poor performance of the fine-particle-coated hollow particles to decrease the specific gravity of compositions containing the hollow particles and require greater amount of the hollow particles in the compositions that means the poor cost performance of the microspheres.

The weight ratio of the monomers contained in the hollow particles (hereinafter referred to as residual monomers) is not specifically restricted and should preferably be not greater than 2000 ppm, more preferably not greater than 1500 ppm, yet more preferably not greater than 1000 ppm, further more preferably not greater than 800 ppm, and most preferably not greater than 400 ppm. The preferable lower limit of the weight ratio of the residual monomers is 0 ppm. The weight ratio of the residual monomers greater than 2000 ppm can cause plasticization of the shell of the hollow particles to result in poor solvent resistance of the particles, or can deteriorate the storage stability of the film-forming composition described below which contains the hollow particles.

The hollow particles immersed in a solvent can decrease their volume because of the escape of the blowing agent, which is encapsulated in the hollow, through the shell of the hollow particles. Thus the true specific gravity of the hollow particles after immersion in a solvent is sometimes greater than the true specific gravity of the hollow particles before the immersion. The solvent resistance (representing the expansion-retention ratio) of the hollow particles is defined as the percentage of the true specific gravity of the hollow particles before immersion in a solvent (initial true specific gravity) to the true specific gravity of the hollow particles after immersion in a solvent (true specific gravity after solvent immersion). The solvent resistance of the hollow particles is measured by the method described in the following examples.

The solvent resistance (expansion-retention ratio) of the hollow particles should preferably be at least 60%, more preferably at least 70%, yet more preferably at least 80%, further more preferably at least 90%, and most preferably 100%. The upper limit of the solvent resistance of the hollow particles is 100%. Hollow particles having an solvent resistance less than 60% have poor solvent resistance, and can deteriorate the storage stability of the film-forming composition mentioned below which contains the hollow particles.

Compositions and Formed Products

The composition contains at least one particulate material selected from the group consisting of the heat-expandable microspheres and hollow particles, and a base component. The heat-expandable microspheres contained in the composition can be obtained by the process for producing heat-expandable microspheres mentioned above.

The weight ratio of the monomers contained in the particulate material (hereinafter referred to as residual monomers) is not specifically restricted, and should preferably be not greater than 2000 ppm, more preferably not greater than 1500 ppm, yet more preferably not greater than 1000 ppm, further more preferably not greater than 800 ppm, and most preferably not greater than 400 ppm. The preferable lower limit of the weight ratio of the residual monomer is 0 ppm. The weight ratio of the residual monomers greater than 2000 ppm can cause the plasticization of the shell of the particulate material to result in poor solvent resistance of the particulate material, or can deteriorate the storage stability of the film-forming composition described below which contains the particulate material.

The base component is not specifically restricted, and includes, for example, rubbers, such as natural rubber, butyl rubber, silicone rubber, and ethylene-propylene-diene rubber (EPDM); thermosetting resins, such as epoxy resins and phenol resins; waxes, such as polyethylene waxes and paraffin waxes; thermoplastic resins, such as ethylene-vinyl acetate copolymer (EVA), polyethylene, polypropylene, polyvinyl chloride resin (PVC), acrylic resin, thermoplastic polyurethane, acrylonitrile-styrene copolymer (AS resin), acrylonitrile-butadiene-styrene copolymer (ABS resin), polystyrene (PS), polyamide resins (nylon 6, nylon 66 etc.), polycarbonate, polyethylene terephthalate (PET), polybutylene terephthalate (PBT), polyacetal (POM), and polyphenylene sulfide (PPS); ionomer resins, such as ethylene ionomers, urethane ionomers, styrene ionomers, and fluorine ionomers; thermoplastic elastomers, such as olefin elastomers and styrene elastomers; bioplastics, such as polylactic acid (PLA), cellulose acetate, PBS, PHA, and starch resins; sealing materials, such as modified silicones, polyurethanes, polysulfides, acrylates, silicones, polyisobutylenes, and butyl rubbers; paint components, such as urethane polymers, ethylene-vinyl acetate copolymers, vinyl chloride polymers, and acrylate polymers; and inorganic materials, such as cement, mortar, and cordierite.

The composition is prepared by mixing these base components and the heat-expandable microspheres and/or hollow particles.

The application of the composition includes, for example, molding compositions; film-forming compositions, such as paint compositions and adhesive compositions; clay compositions; fiber compositions; and powder compositions.

Film-forming compositions contain at least one particulate material selected from the group consisting of the heat-expandable microspheres and hollow particles and a film-forming base component as essential components. The film-forming compositions have good storage stability.

The film-forming base component is not specifically restricted, and includes, for example, vegetable oils and fats, such as soybean oil, flaxseed oil, castor oil, and safflower oil; natural resins, such as rosin, copal, and shellac; synthetic resins, such as alkyd resins, acrylic resins, epoxy resins, polyurethane resins, vinyl chloride resins, silicone resins, and fluorine resins; and rubbers such as natural rubbers, butyl rubbers, silicone rubbers and ethylene-propylene-diene rubbers (EPDM).

Acrylic resins or vinyl chloride resins are preferable film-forming base components for the film-forming composition used as a paint composition for the under-body coating of automobiles because of good film-forming performance. Polyurethane resins are preferable film-forming base component of the film-forming composition used as a paint composition for synthetic leathers because of good feel of resultant leather.

The film-forming composition can further contain an organic solvent. The organic solvent can swell or dissolve a film-forming base component to control the viscosity of the film-forming composition, and improves workability in preparing or painting the film-forming composition. Such effect of the organic solvent is remarkable in the case that the film-forming composition is used as a paint composition or adhesive composition.

The organic solvent includes, for example, aromatic compounds, such as benzene, toluene, and xylene; alcohols, such as, methanol, ethanol, isopropyl alcohol, butanol, and ethylene glycol; hydrocarbons, such as hexane, cyclohexane, and terpene; chlorine-containing compounds, such as chloroform and perchloroethylene; ketones, such as acetone, methylethyl ketone, and cyclohexanone; esters, such as ethyl acetate and butyl acetate; and amides, such as N,N-dimethyl formamide.

The boiling point of the organic solvent is not specifically restricted, and should preferably range from 40° C. to 200° C., more preferably from 45° C. to 190° C., further more preferably from 50° C. to 180° C., and most preferably from 55° C. to 170° C. The organic solvent having a boiling point lower than 40° C. can deteriorate the storage stability of the film-forming composition. On the other hand, the organic solvent having a boiling point higher than 200° C. can decrease the strength of the film formed of the film-forming composition.

The amount of the organic solvent contained in the film-forming composition is not specifically restricted, and should preferably range from 10 to 10000 parts by weight to 100 parts by weight of a film-forming base component, more preferably from 20 to 8000 parts by weight, further more preferably from 40 to 6000 parts by weight, and most preferably from 60 to 4000 parts by weight. The amount of the organic solvent beyond the range mentioned above can result in extremely high or low viscosity of the film-forming composition to impair the workability in painting.

The film-forming composition can further contain a plasticizer, which adjusts the hardness of the film formed of the film-forming composition. The effect is remarkable in the case that the film-forming composition is used as a paint composition or adhesive composition.

Such plasticizer includes, for example, phthalates, such as dibutyl phthalate (DBP), dioctyl phthalate (DOP), diethylhexyl phthalate (DEHP), diisononyl phthalate (DINP), and diheptyl phthalate (DHP); and fatty acid esters, such as diethylhexyl adipate (DOA), diethylhexyl azelate, and diethylhexyl sebacate.

The amount of the plasticizer contained in the film-forming composition is not specifically restricted, and should preferably range from 5 to 2000 parts by weight to 100 parts by weight of a film-forming base component, more preferably from 10 to 1500 parts by weight, further more preferably from 15 to 1000 parts by weight, and most preferably from 20 to 500 parts by weight. The amount of the plasticizer beyond the range mentioned above can result in extremely high or low viscosity of the film-forming composition to impair the workability in painting.

The film-forming base component in a film-forming composition used as an adhesive composition can be referred to as an adhesive component. The adhesive component is not specifically restricted, and includes one-component polyurethane adhesives, two-component polyurethane adhesives, one-component modified silicone adhesives, two-component modified silicone adhesives, one-component polysulfide adhesives, two-component polysulfide adhesives, and acrylic adhesives. The preferable adhesive is at least one selected from the group consisting of one-component polyurethane adhesives, two-component polyurethane adhesives, one-component modified silicone adhesives, and two-component modified silicone adhesives.

The film-forming composition can further contain pigments, defoamers, anti-flooding and anti-floating agents, antifreezing agents, anti-sagging agents, inorganic fillers, and organic fillers.

The composition can be used as the master batch for resin molding if the composition contains the heat-expandable microspheres and a base component including the compounds and/or thermoplastic resins having a melting point lower than the expansion initiation temperature of the heat-expandable microspheres (for example, waxes, such as polyethylene waxes and paraffin waxes; thermoplastic resins, such as ethylene-vinyl acetate copolymer (EVA), polyethylene, polypropylene, polyvinyl chloride resin (PVC), acrylic resin, thermoplastic polyurethane, acrylonitrile-styrene copolymer (AS resin), acrylonitrile-butadiene-styrene copolymer (ABS resin), polystyrene (PS), polycarbonate, polyethylene terephthalate (PET), and polybutylene terephthalate (PBT); ionomer resins, such as ethylene ionomers, urethane ionomers, styrene ionomers, and fluorine ionomers; and thermoplastic elastomers, such as olefin elastomers and styrene elastomers). The master-batch composition for resin molding is preferably employed in injection molding, extrusion molding, and press molding for the purpose of introducing bubbles into molded products. Resins used for rein molding can be selected from the base component mentioned above without restriction, and include, for example, ethylene-vinyl acetate copolymer (EVA), polyethylene, polypropylene, polyvinyl chloride resin (PVC), acrylic resin, thermoplastic polyurethane, acrylonitrile-styrene copolymer (AS resin), acrylonitrile-butadiene-styrene copolymer (ABS resin), polystyrene (PS), polyamide resins (nylon 6, nylon 66, etc.), polycarbonate, polyethylene terephthalate (PET), polybutylene terephthalate (PBT), ionomer resins, polyacetal (POM), polyphenylene sulfide (PPS), olefin elastomers, styrene elastomers, polylactic acid (PLA), cellulose acetate, PBS, PHA, starch resins, natural rubbers, butyl rubbers, silicone rubbers, ethylene-propylene-diene rubbers (EPDM), and their mixtures. The composition can contain reinforcement fibers, such as glass fiber and carbon fiber.

The formed product can be produced by forming the composition. The formed product includes, for example, molded products and coating films. The formed product has improved lightweight effect, porosity, sound absorbing performance, thermal insulation, design potential, shock absorbing performance and strength, and low thermal conductivity and dielectric property.

The formed product containing inorganic materials as the base component can be further fired to be manufactured into ceramic filters, etc.

### EXAMPLE

The examples of the heat-expandable microspheres are specifically described below, though other examples are contemplated herein. The percentage (%) mentioned in the following examples and comparative examples means weight percent (wt %) unless otherwise specified.

The properties of the heat-expandable microspheres, hollow particles, compositions, and formed products were measured and their performances were evaluated by the following methods. The heat-expandable microspheres can be hereinafter referred to as “microspheres” for concise expression.

Mean Particle Size and Particle Size Distribution

Microspheres were analyzed in dry system of a laser diffraction particle size analyzer (HEROS & RODOS, manufactured by SYMPATEC) with the dispersion pressure of 5.0 bar and the vacuum of 5.0 mbar in the dry dispersion unit, and the mean volume diameter D₅₀ determined in the analysis was defined as the mean particle size.

Moisture Content of Microspheres

The moisture content of microspheres was determined with a Karl Fischer moisture meter (MKA-510N, manufactured by Kyoto Electronics Manufacturing Co., Ltd.).

Encapsulation Ratio of a Blowing Agent in Microspheres

1.0 g of microspheres was placed in a stainless steel evaporating dish 15 mm deep and 80 mm in diameter, and weighed out (W1). Then 30 mL of DMF was added to disperse the microspheres uniformly. After being left for 24 hours at room temperature, the microspheres were dried under reduced pressure at 130° C. for 2 hours, and the dry weight (W2) was determined. The encapsulation ratio of the blowing agent (CR) was calculated by the following expression:

CR(wt %)=(W1−W2)(g)/01.0(g)×100−(Moisture content)(wt %)

where the moisture content was calculated in the method mentioned above.

Solvent Resistance of Microspheres

The microspheres without immersion in the solvent mixture mentioned below (the microspheres before immersion in the solvent mixture, hereinafter referred to as the microspheres X) were prepared.

10 parts by weight of the microspheres X was immersed in the mixture of 40 parts by weight of N,N-dimethylformamide and 60 parts by weight of methylethyl ketone, and stood still at a room temperature of 25° C. for 3 days. Then the organic solvents were removed and the microspheres Y immersed in the solvent mixture were prepared.

DMA (DMA Q800, manufactured by TA Instruments) was used for the measurement. In an aluminum cup 4.8 mm deep and 6.0 mm in diameter (5.65 mm in inside diameter), 0.5 mg of the microspheres were placed, and the cup was covered with an aluminum cap 0.1 mm thick and 5.6 mm in diameter to prepare a sample. The sample was subjected to the pressure of 0.01 N with the compression unit of the device, and the height of the sample (H₀) was measured. The sample was then heated at temperatures elevated at a rate of 10° C/min from 20° C. to 300° C., being subjected to the pressure of 0.01 N with the compression unit, and the maximum height of the sample (H) was measured. The maximum change of the height of the sample (Hm) was calculated by the following expression.

Hm=H·H₀

The change in the expansion performance (K) of the microspheres before and after the immersion in the solvent mixture can be calculated from the maximum change of the height of the samples of the microsphere X and microsphere Y by the following expression.

K(%)=(Hm2/Hm1)×100

Hm1: the maximum change of the height of the sample (Hm) of the microsphere X

Hm2: the maximum change of the height of the sample (Hm) of the microsphere Y

K is the indicator of the solvent resistance of the microspheres, and a greater value of K indicates that the heat-expandable microspheres retain better thermal expansion performance after the immersion in the mixture of organic solvents.

The solvent resistance of the microspheres was evaluated according to the following criteria.

High: K≧60

Fair: 60>K≧40

Low: 40>K

Weight Ratio of Residual Monomers in the Particulate Materials (Residual Monomer Ratio)

10 mL of DMF was added to 0.2 g of the particulate material (heat-expandable microspheres and/or hollow particles), and the mixture was shaken at 30° C. for 1 hour to dissolve the particulate material. The resultant solution was centrifuged at 3000 rpm for 2 min, and the residual monomers contained in the supernatant fluid were quantitatively analyzed by gas chromatography, and the weight ratio (ppm) of the residual monomer in the particulate material was calculated.

Parameters for the Gas Chromatographic Analysis

Device: Gas Chromatograph GC-2010 (manufactured by Shimadzu Corporation)

Column: PEG, 30 m×0.25 mm

Column temperature: heating at 60° C. for 5 min, elevation to 250° C. at the rate of 20° C/min, and heating at 250° C. for 12 min

Detection temperature: sample injection at 200° C., detector temperature of 250° C.

Carrier gas: helium

Quantification: Absolute working-curve method (JIS K 0123: 2006)

Reagents for preparing the working curve: acrylonitrile (manufactured by Wako Pure Chemical Industries, Ltd., Wako 1st Grade), methacrylonitrile (manufactured by Wako Pure Chemical Industries, Ltd., Wako Special Grade), methyl methacrylate (manufactured by Wako Pure Chemical Industries, Ltd., Wako Special Grade), and methacrylic acid (manufactured by Wako Pure Chemical Industries, Ltd., Wako Special Grade)

The component quantitatively analyzed in the method mentioned above was confirmed to be the residual monomer in an analysis by gas chromatograph mass spectrometry.

True Specific Gravity of the Fine-Particle-Coated Hollow Particles

The true specific gravity of the fine-particle-coated hollow particles was determined by the liquid substitution method (Archimedean method) with isopropyl alcohol in an atmosphere at 25° C. and 50% RH (relative humidity) as described below.

More specifically, an empty 100-mL measuring flask was dried and weighed (WB₁). Then isopropyl alcohol was poured into the weighed measuring flask to accurately form meniscus, and the measuring flask filled with isopropyl alcohol was weighed (WB₂).

The 100-mL measuring flask was then emptied, dried, and weighed (WS). The weighed measuring flask was then filled with about 50 mL of thermally expanded microspheres, and the measuring flask filled with the hollow particles was weighed (WS₂). Then isopropyl alcohol was poured into the measuring flask filled with the hollow particles to accurately form meniscus without taking bubbles into the isopropyl alcohol, and the flask filled with the hollow particles and isopropyl alcohol was weighed (WS₃). The values, WB_{1,} WB_{2,} WS_{1,} W_{52,} and WS_{3,} were introduced in the following mathematical expression to calculate the true specific gravity (d) of the hollow particles.

d=[(WS₂−WS)×(WB₂−WB₁)/100]/[(WB₂−WB₁)−(WS₃−WS₂)]

Solvent Resistance of Hollow Particles

The hollow particles without immersion in a solvent (the hollow particles before immersion in a solvent, hereinafter referred to as the hollow particles X) were prepared, and the true specific gravity (D1) of the hollow particles X was determined. Then 1 part by weight of the hollow particles X was immersed in 10 parts by weight of methyl ethyl ketone and stood still at room temperature for 3 days to be prepared into the hollow particles Y. The true specific gravity (D2) of the hollow particles Y was determined.

The solvent resistance (expansion-retention ratio) of the hollow particles was calculated from D1 and D2 by the following expression.

Solvent resistance of hollow particles (%)=(D1/D2)×100

### Example 1

### Heat-Expandable Microspheres

An aqueous dispersion medium was prepared by adding 150 g of sodium chloride, 70 g of colloidal silica containing 20 wt % of silica, 1.0 g of polyvinyl pyrolidone, and 0.5 g of ethylenediaminetetraaceticacid tetrasodiumsalt to 600 g of deionized water and controlling the pH of the mixture within the range from 2.8 to 3.2.

An oily mixture was prepared by mixing 65 g of acrylonitrile, 30 g of methacrylonitrile, 5 g of methyl methacrylate, 0.3 g of trimethylolpropane trimethacrylate, 20 g of isopentane, and 2.4 g of 85-% 1,1-bis(t-hexylperoxy)cyclohexane solution (containing 2.0 g of the active ingredient).

The aqueous dispersion medium and the oily mixture were mixed and agitated with a Homo-mixer (manufactured by Primix Corporation) to be prepared into a suspension. Then the suspension was transferred into a compressive reactor of 1.5-liter capacity, purged with nitrogen, and polymerized at 80° C. for 15 hours by agitating the suspension at 80 rpm under the initial reaction pressure at 0.2 MPa. The resultant polymerization product was filtered and dried to be made into the heat-expandable microspheres A. The solvent resistance and the residual monomer ratio of the microspheres were measured and shown in Table 1.

### Examples 2 to 5 and Comparative Examples 1 and 2

The heat-expandable microspheres B to G were produced in the same manner as that in Example 1 except that the components of the oily mixture and their amount and polymerization temperature were replaced by those shown in Table 1. The solvent resistance and the residual monomer ratio of the microspheres were measured and shown in Table 1.

In Example 5, the polymerization was at first carried out at 60° C. for 10 hours (the first step), then the polymerization temperature was elevated to 80° C. over 30 min (the second step), and finally the polymerization was performed at 80° C. for 5 hours (the third step) to produce the heat-expandable microspheres E.

TABLE 1

| | | | | | | | | Comparative | |
|---|---|---|---|---|---|---|---|---|---|
| | | | Examples | | | | | examples | |
| | | | 1 | 2 | 3 | 4 | 5 | 1 | 2 |
| Heat-expandable microspheres | | | A | B | C | D | E | F | G |
| Oily mixture (g) | Monomer component | AN | 65 | 45 | 69 | 45 | 45 | 65 | 45 |
| | | MAN | 30 | 45 | 29 | 45 | 45 | 30 | 45 |
| | | MMA | 5 | 10 | 2 | 0 | 10 | 5 | 10 |
| | | MAA | 0 | 0 | 0 | 10 | 0 | 0 | 0 |
| | Cross-linking agent | TMP | 0.3 | 0.3 | 0.3 | 0.3 | 0.3 | 0.3 | 0.3 |
| | Blowing agent | Isopentane | 20 | 30 | 45 | 10 | 20 | 20 | 20 |
| | Polymerization | Initiator A | 2.0 | 0 | 0 | 0 | 0.01 | 0 | 0 |
| | initiator (amount of | Initiator B | 0 | 2.0 | 0 | 0 | 0 | 0 | 0 |
| | active ingredient) | Initiator C | 0 | 0 | 2.0 | 0 | 0 | 0 | 0 |
| | | Initiator D | 0 | 0 | 0 | 2.0 | 0 | 0 | 0 |
| | | Initiator E | 0 | 0 | 0 | 0 | 0 | 0 | 2.0 |
| | | AIBN | 0 | 0 | 0 | 0 | 2.0 | 2.0 | 0 |

| | | | | | | | | |
|---|---|---|---|---|---|---|---|---|
| Reaction parameters | Temperature (° C.) | 80 | 85 | 80 | 55 | *1 | 60 | 55 |
| | Time (hr) | 15 | 15 | 15 | 15 | | 15 | 15 |
| Properties of | Mean particle size | 23 | 32 | 45 | 10 | 18 | 23 | 18 |
| microspheres | (D50) μm | | | | | | | |
| | Encapsulation ratio (%) | 16 | 23 | 31 | 9 | 16 | 17 | 16 |
| | Ts (° C.) | 125 | 132 | 128 | 134 | 131 | 125 | 130 |
| | Tm (° C.) | 160 | 170 | 180 | 165 | 168 | 161 | 165 |
| | Hm1 (μm) | 2500 | 3200 | 4100 | 1600 | 2200 | 2560 | 1800 |
| | Hm2 (μm) | 2350 | 3100 | 3900 | 1530 | 2100 | 1300 | 840 |
| | Solvent resistance | high | high | high | high | high | fair | low |
| | Residual monomer (ppm) | 640 | 450 | 160 | 200 | 700 | 2530 | 3210 |

*1: polymerization at 60° C. for 10 hr at the first step, elevating the temperature to 80° C. over 30 min at the second step, and polymerization at 80° C. for 5 hr at the third step

The abbreviations shown below represent the monomer components, polymerization initiator, and cross-linking agent in Table 1.

AN: acrylonitrile

MAN: methacrylonitrile

MMA: methyl methacrylate

MAA: methacrylic acid

AIBN: azobisisobutylonitrile

TMP: trimethylolpropane trimethacrylate

The detailed properties of the polymerization initiators A to F in Table 1 are shown in Table 2.

TABLE 2

| | | Number | | | | |
|---|---|---|---|---|---|---|
| | | of | | Theoretical | | 10-hr |
| | | active | | active | | half-life |
| | | oxygen | Molecular | oxygen | Concentration | temperature |
| Initiator | Chemical name | bonds | weight | content (%) | (%) | (° C.) |
| A | 1,1-Bis(t-hexylperoxy)cyclohexane | 2 | 316 | 10.1 | 85 | 87 |
| B | 2,2-Bis(4,4-di-t-butylperoxycyclohexyl)propane | 4 | 560 | 11.4 | 20 | 95 |
| C | Di-t-butylperoxyhexahydroterephthalate | 2 | 316 | 10.1 | 65 | 83 |
| D | t-Amilperoxypivalate | 1 | 188 | 8.5 | 75 | 55 |
| E | Di-2-ethylhexylperoxydicarbonate | 1 | 398 | 4 | 70 | 62 |

### Example A1

### Polyurethane Coating Film

A polyurethane paint composition was prepared by mixing 10 g of the heat-expandable microspheres B and 90 g of a polyurethane binder (composed of 21% of polyurethane solid and 79% of the mixture of organic solvents containing methyl ethyl ketone, toluene, acetone and N,N-dimethylformamide in the ratio of 40:20:10:30).

The polyurethane paint composition was spread on a base fabric with a coater to make coating film which would be 0.3-mm thick after drying. Then the thickness (T2) of the film dried at room temperature was measured by a film thickness meter, and the result was 0.3 mm. Then the coating film on the fabric was heated in a preheated gear oven at 180° C. for 2 min to be made into expanded polyurethane coating film.

The thickness (T1) of the expanded polyurethane coating film was measured in the same manner as that mentioned above, and the result was 1.8 mm. The expansion ratio of the polyurethane coating film was calculated by the following expression, and the result was 6 times.

Expansion Ratio (Times)=T1/T2

Then the polyurethane paint composition was stored at 40° C. for 7 days. The composition after the storage was formed into a 0.3-mm thick dry coating film and the film was expanded into 1.8 mm-thick coating film in the same manner as that mentioned above. The expansion ratio of the polyurethane coating film was 6 times, which was the same as that mentioned above, to show that the expansion performance did not change during the storage. Thus the polyurethane paint composition exhibited good storage stability.

### Example A2

### Polyurethane Coating Film

A polyurethane paint composition was prepared in the same manner as that in Example A1 except that the heat-expandable microspheres B were replaced by the heat-expandable microspheres C obtained in Example 3, and the properties of the resultant polyurethane paint composition were measured in the same manner as that in Example A1.

The thickness (T1) of the expanded polyurethane coating film was measured in the same manner as that mentioned above, and the result was 1.5 mm. The expansion ratio of the polyurethane coating film was calculated, and the result was 5 times.

Then the polyurethane paint composition was stored at 40° C. for 7 days. The composition after the storage was formed into a 0.3-mm thick dry coating film and the film was expanded into 1.5 mm-thick coating film in the same manner as that mentioned above. The expansion ratio of the polyurethane coating film was 5 times, which was the same as that mentioned above and proved that the expansion performance did not change during the storage. Thus the polyurethane paint composition exhibited good storage stability.

### Comparative Example A1

A polyurethane paint composition was prepared in the same manner as that in Example A1 except that the heat-expandable microspheres B were replaced by the heat-expandable microspheres F obtained in Comparative example 1, and the properties of the resultant polyurethane paint composition were measured in the same manner as that in Example A1.

The expansion ratio of the polyurethane coating film made of the fresh polyurethane composition was 3.3 times. The expansion ratio of the polyurethane coating film made of the polyurethane paint composition stored at 40° C. for 7 days decreased to 1.5 times. The heat-expandable microspheres F contained in the composition had poor solvent resistance and led to the decreased expansion ratio after the storage of the polyurethane paint composition. Thus the polyurethane paint composition exhibited poor storage stability.

### Example B1

### Vinyl Chloride Resin Coating Film

A vinyl chloride resin binder was prepared by mixing 100 g of PVC paste (PCH-175, produced by Kaneka Corporation), 100 g of diisononyl phtharate (SANSO CIZER, produced by New Japan Chemical Co., Ltd) and 200 g of calcium carbonate (Whiten SB Red, produced by Bihoku Funka Kogyo Co., Ltd.).

A vinyl chloride resin paint composition was prepared by mixing 1 g of the heat-expandable microspheres A obtained in Example 1 and 99 g of the vinyl chloride resin binder.

The vinyl chloride resin paint composition was spread on a Teflon™ sheet to make 1.5-mm thick coating film. Then the film was heated in a preheated gear oven at 140° C. for 30 min to be made into expanded vinyl chloride resin coating film.

The density (D2) of the expanded vinyl chloride resin coating film was determined in the liquid substitution method, and the result was 0.8 g/cm³. On the other hand, the density (D1) of the vinyl chloride resin coating film which does not contain the heat-expandable microspheres A was determined in the liquid substitution method, and the result was 1.6 g/cm³. The expansion ratio of the vinyl chloride resin coating film was calculated by the following expression, and the result was 2 times.

Expansion Ratio (Times)=D1/D2

Then the vinyl chloride resin paint composition was stored at 40° C. for 7 days, and formed into an expanded vinyl chloride resin coating film in the same manner as mentioned above. The expansion ratio of the vinyl chloride resin coating film was 2 times, which was the same as that mentioned above and proved that the expansion ratio did not change during the storage. Thus the vinyl chloride resin paint composition exhibited good storage stability.

### Example B2

### Vinyl Chloride Resin Coating Rilm

A vinyl chloride resin paint composition was prepared in the same manner as that in Example B1 except that the heat-expandable microspheres A were replaced by the heat-expandable microspheres D obtained in Example 4. The properties of the composition were measured in the same manner as that in Example B1.

The density (D2) of the expanded vinyl chloride resin coating film made of the composition was determined in the liquid substitution method, and the result was 0.7 g/cm³. On the other hand, the density (D1) of the vinyl chloride resin coating film which does not contain the heat-expandable microspheres D was determined in the liquid substitution method, and the result was 1.6 g/cm³. The expansion ratio of the vinyl chloride resin coating film was calculated, and the result was 2.3 times.

Then the vinyl chloride resin paint composition was stored at 40° C. for 7 days, and formed into an expanded vinyl chloride resin coating film in the same manner as mentioned above. The expansion ratio of the vinyl chloride resin coating film was 2 3 times, which was the same as that mentioned above and proved that the expansion ratio did not change during the storage. Thus the vinyl chloride resin paint composition exhibited good storage stability.

### Comparative Example B1

A vinyl chloride resin paint composition was prepared in the same manner as that in Example B1 except that the heat-expandable microspheres A were replaced by the heat-expandable microspheres G obtained in Comparative example 2. The properties of the composition were measured in the same manner as that in Example B1.

The expansion ratio of the vinyl chloride resin coating film made of the fresh vinyl chloride resin paint composition was 1.6 times. On the contrary, the expansion ratio of the vinyl chloride resin coating film made of the vinyl chloride resin paint composition stored at 40° C. for 7 days decreased to 1.1 times. The heat-expandable microspheres G had poor solvent resistance and led to the decreased expansion ratio after the storage of the vinyl chloride resin paint composition. Thus the vinyl chloride resin paint composition exhibited poor storage stability.

### Example C1

### Fine-Particle-Coated Hollow Particles

The mixture of 25 g of the heat-expandable microspheres A produced in Example 1 and 75 g of heavy calcium carbonate (MC-120, manufactured by Asahi Kohmatsu Co., Ltd.) was prepared and transferred in a 2-liter separable flask preheated in a heating mantle up to 90 to 110° C. Then the mixture was agitated with a PTFE stirrer blade (150 mm long) at 600 rpm at a temperature controlled to make fine-particle-coated hollow particles A having a true specific gravity of 0.12±0.03 in about 5 min.

The resultant fine-particle-coated hollow particles A had a true specific gravity (D1) of 0.12 and contained 600 ppm of residual monomers. The true specific gravity (D2) of the fine-particle-coated hollow particles A after immersion in methyl ethyl ketone at room temperature for 3 days was 0.13, which was measured in the same manner as that mentioned above. The solvent resistance (expansion-retention ratio) of the fine-particle-coated hollow particles calculated from D1 and D2 was 92%. [00861

### Example C2

### Fine-Particle-Coated Hollow Particles

Fine-particle-coated hollow particles E were prepared in the same manner as that in Example C1 except that the heat-expandable microspheres A were replaced by the heat-expandable microspheres E obtained in Example 5.

The resultant fine-particle-coated hollow particles E had a true specific gravity (D1) of 0.10 and contained 180 ppm of residual monomers. The true specific gravity (D2) of the fine-particle-coated hollow particles E after immersion in methyl ethyl ketone at room temperature for 3 days was 0.11, which was measured in the same manner as that mentioned above. The solvent resistance (expansion-retention ratio) of the fine-particle-coated hollow particles was 91%.

### Comparative Example C1

Fine-particle-coated hollow particles G were prepared in the same manner as that in Example C1 except that the heat-expandable microspheres A were replaced by the heat-expandable microspheres G obtained in Comparative example 2. The resultant fine-particle-coated hollow particles G had a true specific gravity of 0.12 and contained 3000 ppm of residual monomers. The true specific gravity of the fine-particle-coated hollow particles G after immersion in methyl ethyl ketone at room temperature for 3 days was 0.32, and the solvent resistance (expansion-retention ratio) of the fine-particle-coated hollow particles G was 38%. The expansion ratio of the fine-particle-coated hollow particles G decreased after the immersion in methyl ethyl ketone to show poor solvent resistance of the hollow particles G.

### Example D1

A mixture was prepared by adding 4.3 parts by weight of a color toner, 1.75 parts by weight of the fine-particle-coated hollow particles A obtained in Example C1, and 2 parts by weight of dodecane to 87 parts by weight of the base component of a two-component modified silicone adhesive (containing 40% of modified silicone polymer solid of the two-component adhesive and 60% of diisononyl phthalate as a plasticizer, and having a specific gravity of 1.12). Then the mixture was premixed, agitated with a planetary mixer (PVM-5, manufactured by Asada Iron Works Co., Ltd.) at the revolution speed of 24 rpm and rotation speed of 72 rpm at 70° C. for 1 hour, and cooled down to 25° C. to be prepared into the base compound.

Then 8.7 parts by weight of the curing agent of the two-component modified silicone adhesive was added to the base compound and the mixture was agitated and defoamed with a conditioning mixer (AR-360, manufactured by Thinky Corporation) at the rotation speed of 500 rpm and revolution speed of 2000 rpm for 150 seconds to be prepared into an adhesive composition.

The adhesive composition was spread on a polyethylene sheet to be made into two samples of coating film each being 10 mm wide, 60 mm long and 3 mm thick. One of the samples was cured under the curing condition 1 described below to be made into a cured sample 1. The density of the cured sample 1 was determined in the liquid substitution method, and the result was 0.90 g/cm³. Another sample was cured under the curing condition 2 described below to be made into a cured sample 2. The density of the cured sample 2 was determined in the liquid substitution method, and the result was also 0.90 g/cm³. The same density of the cured samples 1 and 2 showed that the adhesive composition had good storage stability.

Curing condition 1: curing at 50° C. and 50% RH for 3 days

Curing condition 2: curing at 23° C. and 50% RH for 3 days followed by curing at 50° C. and 50% RH for 3 days

### Example D2

An adhesive composition was prepared in the same manner as that in Example D1 except that the fine-particle-coated hollow particles A was replaced by the fine-particle-coated hollow particles E obtained in Example C2. The composition was made into two samples of coating film. One of the samples was cured under the curing condition 1 to be made into the cured sample 1, which had the density of 0.91 g/cm³.

Another sample was cured under the curing condition 2 to be made into the cured sample 2, which also had the density of 0.91 g/cm³. The same density of the cured samples 1 and 2 shows that the adhesive composition had good storage stability.

### Comparative Example D1

An adhesive composition was prepared in the same manner as that in Example D1 except that the fine-particle-coated hollow particles A was replaced by the fine-particle-coated hollow particles G obtained in Comparative example C1. The composition was made into two samples of coating film. One of the samples was cured under the curing condition 1 to be made into the cured sample 1, which had the density of 0.90 g/cm³.

Another sample was cured under the curing condition 2 to be made into the cured sample 2, which had the density of 1.09 g/cm³. The considerable difference between the densities of the cured samples 1 and 2 showed that the adhesive composition had poor storage stability.

### Example E1

### Composition and Formed Product

The mixture of 200 g of the heat-expandable microspheres B obtained in Example 2 and 200 g of ethylene-vinyl acetate copolymer (having a melting point of 61° C.) were prepared. The mixture was melted and mixed with a 0.5-liter pressure kneader at 75° C., and formed into pellets each 3 mm long and 3 mm in diameter, which was the master batch B (MB-B) containing 50 wt % of the heat-expandable microspheres B.

Then 94 parts by weight of a low-density polyethylene (DNDV-0405R, produced by the Dow Chemical Company, having a melting point of 108° C. and density of 0.914) and 6 parts by weight of the master batch (MB-B) were uniformly mixed to be prepared into a low-density polyethylene composition.

The low-density polyethylene composition was injection molded at 160° C. by a 85 tf injection molder (J85AD, manufactured by The Japan Steel Works, Ltd., equipped with a shut-off nozzle which controls the expansion of the heat-expandable microspheres in the cylinder to stabilize the lightweight effect) to be made into a formed product. The expansion ratio of the resultant formed product was 2.3 times.

The expansion ratio of the formed product was calculated from the densities of the composition and formed product. The densities of the formed product (D2) made of the low-density polyethylene composition and the density (D1) of the low-density polyethylene composition before molding were determined in the liquid substitution method with a precision densimeter AX200 (manufactured by Shimadzu Corporation). The expansion ratio was calculated from D1 and D2 by the following expression.

Expansion ratio (times)=D1/D2

### INDUSTRIAL APPLICABILITY

The process efficiently produces heat-expandable microspheres having high solvent resistance. The heat-expandable microspheres retain stable expansion ratio in an organic solvent, and are useful for film-forming compositions, such as paint compositions, adhesive compositions and synthetic-leather compositions.

### REFERENCE SIGNS LIST

11 Shell of thermoplastic resin

12 Blowing agent

1 Hollow particles (fine-particle-coated hollow particles)

2 Shell

3 Hollow

4 Fine particle (in a state of adhesion)

5 Fine particle (in a state of fixation in a dent)

1.-12. (canceled)

13. A process for producing heat-expandable microspheres comprising a shell of a thermoplastic resin and a blowing agent encapsulated therein and vaporizable by heating, the process comprising the steps of:
preparing an aqueous suspension by dispersing an oily mixture in an aqueous dispersion medium, wherein the oily mixture contains a polymerizable component, the blowing agent, and a polymerization initiator containing, as an essential component, a peroxide A having a theoretical active oxygen content of at least 7.8%; and
polymerizing the polymerizable component in the oily mixture.

14. The process for producing heat-expandable microspheres according to claim 13, wherein the polymerizable component contains a nitrile monomer as an essential component.

15. The process for producing heat-expandable microspheres according to claim 13, wherein the peroxide A is a peroxyester and/or a peroxyketal.

16. The process for producing heat-expandable microspheres according to claim 13, wherein the peroxide A is a compound containing a ring structure in a molecule.

17. The process for producing heat-expandable microspheres according to claim 13, wherein the number of the active oxygen bonds of the peroxide A is in the range of 2 to 5 per molecule.

18. The process for producing heat-expandable microspheres according to claim 13, wherein the molecular weight of the peroxide A is at least 275.

19. The heat-expandable microspheres produced in the process according to claim 13.

20. Hollow particles produced by heating and expanding the heat-expandable microspheres according to claim 19.

21. The hollow particles according to claim 20, wherein outers surface of the hollow particles are coated with fine particles.

22. A composition containing a base component and at least one particulate material selected from the group consisting of the heat-expandable microspheres according to claim 19.

23. The composition according to claim 22, the composition being a film-forming composition.

24. A product manufactured using the composition according to claim 22.

25. A product manufactured using the composition according to claim 23.

26. A composition containing a base component and at least one particulate material selected from the group consisting of the hollow particles according to claim 20.

27. The composition according to claim 26, the composition being a film-forming composition.

28. A product manufactured using the composition according to claim 26.

29. A composition containing a base component and at least one particulate material selected from the group consisting of the hollow particles according to claim 21.

30. The composition according to claim 29, the composition being a film-forming composition.

31. A product manufactured using the composition according to claim 29.
